(19) United States
(12) Patent Application Publication
(10) Pub. No.: US 2007/0087245 A1
(43) Pub. Date: Apr. 19, 2007

(54) Multilayer polyelectrolyte membranes for fuel cells

(76) Inventors: Timothy J. Fuller, Pittsford, NY (US); Beba T. Dobulis, Fairport, NY (US)

Correspondence Address: GARY W. BROOKS;General Motors Corporation, Mail Code 482-C23-B21, P.O. Box 300, Detroit, MI, 48265-3000, US

(21) Appl. No.: 11/250,851

(22) Filed: Oct. 14, 2005

(51) Int. Cl. H01M 8/10

(52) U.S. Cl. 429/33; 429/32

(57) ABSTRACT

Polyelectrolyte membranes are multilayer composites, comprising a plurality of porous or expanded fluoropolymer support layers having macromolecules, polymer aggregates and particles of ionomers with proton exchange groups imbibed into pores of the support layers. Preferred membranes contain two or three support layers. Exemplary support layers include expanded fluoropolymer materials such as expanded polytetrafluoroethylene (ePTFE). In one embodiment perfluorosulfonic acid ionomers are imbibed into pores of the support layers.

### FIELD OF THE INVENTION

This invention relates to improved fuel cells for generating electromotive force to power electric motors. In particular, the invention relates to improved polyelectrolyte membranes having a plurality of structural layers.

### BACKGROUND OF THE INVENTION

Fuel cells are increasingly being used as power sources for electric vehicles and other applications. An exemplary fuel cell has a membrane electrode assembly with catalytic electrodes and a membrane formed between the electrodes. Hydrogen fuel is supplied to the anode side of the assembly, while oxygen is supplied to the cathode. The membrane provides an electrical connection between the anode and cathode, and provides a medium through which fuel oxidation products are transported from the anode to combine with the reduced oxygen at the cathode. The overall reaction in the fuel cell is the combination of hydrogen and oxygen to yield water and an electromotive potential. Because the oxidation product of the fuel is essentially H⁺or a proton, the polyelectrolyte membrane is also known as a proton conducting membrane or a proton exchange membrane (PEM).

The industry is constantly looking for membrane materials that conduct protons efficiently over a wide range of temperature and humidity conditions. Improved proton conducting membranes are required to meet cost, performance, and durability targets for such membranes, especially in automotive applications. Perfluorosulfonic acid (PFSA) membranes are typically chosen for use in fuel cells because of their advantageous combination of oxidation and thermal stability and acceptable proton conductivity at low relative humidity.

In general, performance of PFSA membranes depends on ionic exchange capacity and the structure of the films, including its physical properties. In some instances, mechanical properties of the membranes are sacrificed in order to provide membranes having sufficiently high proton conductivity.

Accordingly, materials suitable for use as proton exchange membranes (PEM) in fuel cells having a combination of high current density at high cell voltage and robust physical properties such as resistance to tear would be a significant advance.

### SUMMARY OF THE INVENTION

The invention provides improved perfluorosulfonic acid membranes intended for use in PEM fuel cells operating at elevated temperatures and low relative humidity. Polyelectrolyte membranes of the invention are multilayer composites, wherein the composites comprise a plurality of porous or expanded fluoropolymer support layers, and wherein particles, polymer aggregates, or macromolecules of ionomers containing proton exchange groups are imbibed into pores in the support layers. Preferred embodiments include membranes containing two support layers or three support layers. Exemplary materials for the support layers include expanded fluoropolymer materials such as expanded polytetrafluoroethylene (ePTFE). In one embodiment, perfluorosulfonic acid ionomer is imbibed into pores of the support layers.

Fuel cells based on the polyelectrolyte membrane include a membrane electrode assembly having a cathode, an anode, and a proton exchange membrane disposed between the cathode and anode, wherein the proton exchange membrane is a polyelectrolyte membrane of the invention. Fuel cells stacks contain a plurality of such fuel cells, and are operated by supplying hydrogen to the anode and oxygen to the cathode to generate an electromotive force that can be used to power electric motors.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-sectional view of a multilayer polyelectrolyte membrane; and

FIG. 2 is a schematic diagram of a fuel cell stack.

### DETAILED DESCRIPTION OF THE PREFERRED EMBODIMENTS

In one embodiment, the invention provides a multilayer composite membrane suitable for use as a proton exchange membrane in a PEM fuel cell. The composite membrane is made of two or more adjacent layers of support structures imbibed with ionomer. The support structure is made of a fluoropolymeric material and has a porous microstructure. The ionomer imbibed into the support structures are made of polymeric materials containing a proton transporting group. In various embodiments, the ionomers take the form of particles, macromolecules, and/or polymer aggregates. Exemplary ionomers include polymers containing sulfonate groups such as perfluorosulfonic acids.

In another embodiment, the invention provides a membrane electrode assembly suitable for use in a PEM fuel cell. The electrode assembly is made of a cathode, an anode, and a proton exchange membrane disposed between the cathode and the anode, wherein the proton exchange membrane is a multilayer composite membrane as described herein. Preferably, the proton exchange membrane is a multilayer composite having a plurality of expanded perfluoropolymer support layers, with particles of perfluorosulfonic acid polymers being imbibed into pores of the support layers.

In another embodiment, the invention provides methods for making multilayer composites suitable for use as proton exchange membranes. In one embodiment, the method comprises imbibing ionomer into a first support layer, drying the first support layer under tension, imbibing ionomer (as particles, macromolecules, or polymer aggregates) into a second support layer and laying the second layer onto the dried or partly-dried first support layer. The resulting intermediate structure is then dried; optionally subsequent layers are imbibed, laid up, and dried until a composite having a desired thickness and number of layers is built up. A second portion of ionomer is then imbibed into the first and second support layers, followed by air or oven drying. The methods can be used to form composite structures having two, three, or more support structure layers.

In another embodiment, a method for making multilayer composites of the invention involves laying down a plurality of porous support structures on top of one another, followed by imbibing ionomer such as PFSA into the multilayer intermediate structure. The imbibed intermediate structure is then air or oven dried to produce the multilayer composite structure made of a plurality of porous support layers having particles of ionomer imbibed into pores in the support layers.

In another embodiment, the invention provides a method of operating a PEM fuel cell to supply an electromotive force for use in operation of electrically driven motors. The method comprises supplying hydrogen to an anode and oxygen to a cathode of a PEM fuel cell, wherein the fuel cell contains a membrane electrode assembly and a proton exchange membrane as described herein. Preferably, support layers in the multilayer composite membrane are made of a porous fluoropolymer such as an expanded polytetrafluoroethylene. In various embodiments, the invention also provides methods for activating electric motors, comprising generating an electromotive force by operating fuel cells such as described herein to generate the electromotive force, and then activating the motor.

The membrane electrode assembly and fuel cells of the invention are based on a multilayer composite membrane suitable for use as a proton exchange membrane. The membrane contains a plurality of support layers that are made of polymeric material, preferably perfluoropolymeric material, having a porous microstructure. The porous microstructure is characterized by a measurement of pore volume of about 30% to about 95% by the mercury method. Within this range, values above about 70% are preferable in some cases, because the support structure tends to be more easily filled with ionomer. However, as support porosity increases, the strength of the support structure tends to diminish. Consequently, a trade off exists between the ease of filling of the pores with ionomer and the optimum strength of the ionomer filled composite.

The porosity of support layers can also be characterized by measurements made on a Gurley Densometer, used according to ASTM Method 0726-058. The Gurley airflow test measures the time in seconds for 100 cc of air to flow through a 1 in. sq. (6.45 cm²) sample at 4.88 in. (124 mm) of water pressure. This 124 mm represents the water level difference in a u-shaped tube due to the air (pressure) forced against that of the water. The longer the time in seconds for the airflow, the lower is the relative porosity of the membrane tested. In one embodiment, the porous microstructure is characterized by Gurley airflow test numbers in a range corresponding to that measured on microstructures with a pore volume of about 30 to about 95%. In some embodiments, Gurley numbers for the porous microstructures are from 2 to 4 seconds, which provides structures relatively. easy to fill with ionomer. Commercial porous microstructures include the Tetratex® ePTFE of Donaldson (85 Railroad Drive, Ivyland, Pa. 18974), having porosity characterized by Gurley numbers of less than 0.2 sec (extremely porous) to about 7.7 sec (corresponding to relatively low porosity, requiring extended time such as about 1.5 hours to fill the pores with ionomer). In various embodiments, the porous microstructures are characterized by Gurley numbers of from about 0.1 to about 8 seconds.

In addition to a plurality of support layers adjacent to one another as described above, the multilayer composite membranes contain ionomers imbibed into each support layer of the membrane, filling or partially filling the voids or pores in the porous microstructure of the individual support layers. Ionomer is imbibed into pores in the individual support layers and is also found between the layers in the interface between adjacent layers, acting as a glue or adhesive to hold the layers together.

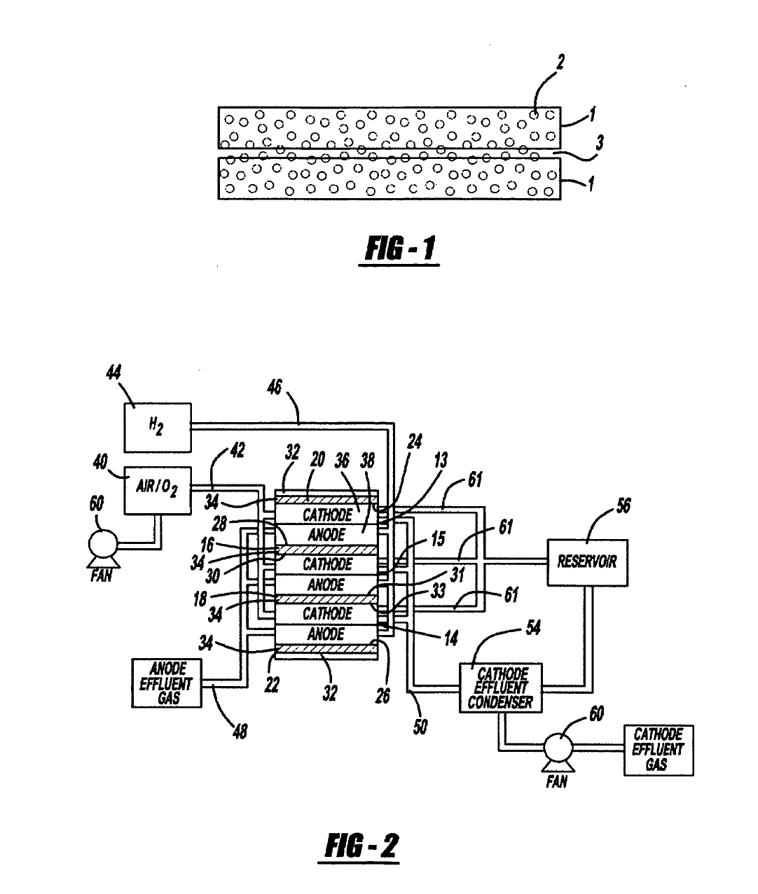

FIG. 1 illustrates the concepts involved in describing the structure of the multilayer composite membrane. FIG. 1 shows a cross sectional view of a multilayer composite. As illustrated, a plurality of support layers 1 are adhered in adjacent fashion to one another, and ionomer 2, shown as particles, is imbibed into each support layer and into the interface 3 between adjacent support layers 1. In other embodiments, the multilayer composites contain three or further layers, not illustrated in FIG. 1. In a preferred embodiment, the multilayer composites of the invention are suitable for use as proton exchange membranes in PEM fuel cells. Such fuel cells operate according to known principles in which fuel comprising hydrogen is supplied to the anode of the fuel cell and an oxidant gas containing oxygen is supplied to the cathode.

Membrane electrode assemblies of the invention comprise two electrodes with a multilayer composite of the invention disposed between the electrodes as a proton exchange membrane. The electrodes are an anode and a cathode for use in carrying out the overall production of water from fuel containing hydrogen and an oxidant gas containing oxygen. In various embodiments, the electrodes contain carbon support particles on which smaller catalyst particles (such as platinum) are disposed, the carbon and catalyst being supported generally on a porous and conductive material such as carbon cloth or carbon paper. Suitable electrodes are commercially available; in some embodiments, the anode and cathode are made of the same material.

In preferred embodiments, fuel cell stacks comprising a plurality of fuel cells are used to provide increased electromotive force. Exemplary fuel cell stacks contain from 5 to 500 individual fuel cells joined electrically in series. Other exemplary fuel cell stacks contain from 10 to 500, from 10 to 200, from 10 to 100, and from 20 to 100 individual fuel cells, depending on the voltage and power density requirements. A single fuel cell produces a low voltage which depends on operating conditions but is typically about 0.7 volts. To generate enough electricity to power a vehicle, cells are stacked together in series to provide higher electromotive force.

Referring generally to FIG. 2, three individual proton exchange membrane (PEM) fuel cells according to one preferred embodiment of the present invention are connected to form a stack. Although only three cells are shown in FIG. 2 for clarity, it is to be understood the principles of operation also hold for stacks containing a higher number of cells. Each PEM fuel cell has membrane-electrode-assemblies (MEA) 13, 15, 14, respectively, separated from one another by electrically conductive, impermeable separator plates 16, 18, and further sandwiched between terminal separator plates 20,22 at each end of the stack with each terminal plate 20,22 having only one electrically active side 24,26. An individual fuel cell, which is not connected in series within a stack, has a separator plate, with only a single electrically active side. In a multiple fuel cell stack, such as the one shown, a preferred bipolar separator plate 16 typically has two electrically active sides 28,30 respectively facing a separate MEA 13, 15 with opposite charges that are separated, hence the so-called “bipolar” plate. As described herein, the fuel cell stack has conductive bipolar separator plates in a stack with multiple fuel cells however the present invention is equally applicable to conductive separator plates within a stack having only a single fuel cell.

The MEAs 13, 15, 14 and bipolar plates 16, 18 are stacked together between aluminum clamping plates 32 at each end of the stack and the end contact terminal plate elements 20,22. The end contact terminal plate elements 20,22, as well as working faces 28,30 and 31,33 of both bipolar separator plates 16, 18, contain a plurality of gas flow channels (not shown) for distributing fuel and oxidant gases (i.e., H₂ & O₂) to the MEAs 13, 15, 14. Nonconductive gaskets or seals (not shown) provide seals and electrical insulation between the several components of the fuel cell stack. Gas-permeable conductive diffusion media 34 press up against the electrode faces of the MEAs 13, 15, 14. When the fuel cell stack is assembled, the conductive gas diffusion layers 34 assist in even distribution of gas across the electrodes of the MEAs 13, 15, 14 and also assist in conducting electrical current throughout the stack.

An inlet for oxygen adjacent the cathode and an inlet for hydrogen adjacent the anode are also provided. Oxygen is supplied to the cathode side 36 of each fuel cell in the stack from storage tank 40 via appropriate supply plumbing 42 to provide an inlet for oxygen adjacent the cathode, while hydrogen is supplied to the anode side 38 of the fuel cell from storage tank 44, via appropriate supply plumbing 46 to provide an inlet for hydrogen adjacent the anode. Alternatively, air may be supplied to the cathode side 36 from the ambient, and hydrogen to the anode 38 from a methanol or gasoline reformer, or the like. Exhaust plumbing for the anode side 48 and the cathode side 50 of the MEAs 13, 15, 14 are provided. On the cathode side, the plumbing defines an exit side. Gas flow into and out of the stack is typically facilitated by fans 60, such as those shown in the exemplary configuration of FIG. 2. Any means of transporting fluids into and out of the stack are feasible, and the configuration and number of fans shown is merely exemplary and not limiting.

As shown in FIG. 2, the cathode effluent 50 is routed from the stack to a condenser 54, which serves to liquefy and recover the vapors in the cathode effluent stream 50. The liquids (e.g. water) are transported to a reservoir 56 for storage. The effluent stream 50 from the cathode has a high concentration of vapor (water vapor, for example) due to the water generated by the electrochemical reactions occurring within the MEA and any additional water introduced for cooling. The water evaporates due to pressure and temperature conditions within the fuel cell. Preferably, the effluent stream is saturated with vapor (e.g. in the case of water at approximately 100% relative humidity). As shown, the supply conduits 61 provide water to the cathode side of each MEA 13, 15, 14 by interconnecting the reservoir 56 to the fuel cells in the stack. A pump (not shown) may optionally be included in the system to facilitate the transport of the liquid from the reservoir 56 to the stack, or through other areas of the system.

Suitable support layers for making the multilayer composites of the invention are made of material provided in the form of porous films characterized for example by pore size and Gurley number as described above. In one embodiment, the material of the support layers is a so-called expanded fluoropolymer such as is made in accordance with the teachings of U.S. Pat. No. 3,593,566 to W. L. Gore & Associates, the disclosure of which is herein incorporated by reference. Preferably, the material has a porosity of greater than 35% and preferably between about 70% and 95%. The thickness of the porous membrane is preferably less than about 2 mils, and more preferably, is about 1 mil or less (where 1 mil=0.025 mm). In various embodiments as disclosed in the Gore patent, the internal porous microstructure of the expanded fluoropolymer is made of nodes interconnected by fibrils of fluoropolymer.

In another embodiment, the material of the support layer contains a perfluoropolymeric material having a porous microstructure defined substantially as consisting of fibrils with no nodes present. Such materials are referred to as a nonwoven web. Whether characterized by nodes interconnected by fibrils, or by fibrils with no nodes present, the material of the support layer provides a porous microstructure into which ionomer can be imbibed.

In various embodiments, the multilayer composites are made of support layers characterized by an orientation of fibers, corresponding for example to the stretching direction of ePTFE membranes. Multilayer composites are preferably made by laying up a successive layer or layers of individual support layers so that the fiber direction of adjacent layers in the resulting composite is offset from one another by an amount from −90° to +90°. In various embodiments, the absolute value of the offset is greater than about 100, for example, about 22.50 or more and about 45° or more. In a preferred embodiment, the offset is plus or minus 90°.

The fluoropolymer or fluorine containing polymer for the porous support layer includes preferably polytetrafluoroethylene (PTFE) or a copolymer of tetrafluoroethylene with other perfluoromonomers such as
CF₂═CFCₙF₂ₙ₊₁
wherein n is 1 to 5, and/or 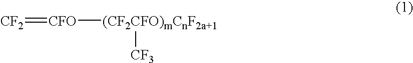
wherein m is 0 to 15 and n is 1 to 15.

Perhalogenated polymers such as polychlorotrifluoroethylene may also be used, but perfluorinated supports have the best resistance to heat and chemicals.

A preferred fluorinated polymer is a polymer having an aliphatic ring structure containing fluorine, for example an amorphous polymer of perfluoro-2,2-dimethyl-1,3-dioxole. In embodiments, the polymer is a homopolymer of perfluoro-2,2-dimethyl-1,3-dioxole. In other embodiments, the polymer is a copolymer of perfluoro-2,2-dimethyl-1,3-dioxole, including copolymers having a complementary amount of at least one monomer selected from the group consisting of tetrafluoroethylene, perfluoromethyl vinyl ether, perfluoropropylene, vinylidene fluoride and chlorotrifluoroethylene. In preferred embodiments, the polymer is a dipolymer of perfluoro-2,2-dimethyl-1,3-dioxole and a complementary amount of tetrafluoroethylene, especially such a polymer containing 65-99 mole % of perfluoro-2,2-dimethyl-1,3-dioxole. The amorphous polymer preferably has a glass transition temperature of at least 140° C., and more preferably of at least 160° C. Glass transition temperature (T_{g}) is known in the art and is the temperature at which the polymer changes from a brittle, vitreous or glassy state to a rubbery or plastic state.

Examples of copolymers are described in further detail in U.S. Pat. No. 4,754,009 and U.S. Pat. No. 4,935,477, both of E. N. Squire. The polymer may, for example, be an amorphous copolymer of perfluoro(2,2-dimethyl-1,3-dioxole) with a complementary amount of at least one other comonomer, said copolymer being selected from dipolymers with perfluoro(butenyl vinyl ether) and terpolymers with perfluoro(butenyl vinyl ether) and with a third comonomer, wherein the third comonomer can be (a) a perhaloolefin in which halogen is fluorine or chlorine, or (b) a perfluoro(alkyl vinyl ether); the amount of the third comonomer, when present, preferably being at most 40% by mole of the total composition. Polymerization is performed by methods known in the art.

Other suitable polymers having an aliphatic ring structure containing fluorine are described in U.S. Pat. No. 4,897,457 of Nakamura et al. and Japanese Published Patent Application Kokai 4-198918 of Nakayama et al.; e.g., a fluorine-containing thermoplastic resinous polymer comprising a group of repeating units to be represented by the following general formula: 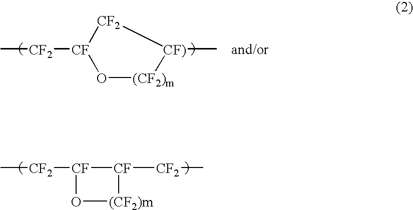
(wherein n is an integer of 1 or 2); and copolymers thereof.

The glass transition temperature of the amorphous polymer will vary with the actual polymer of the membrane, especially the amount of tetrafluoroethylene or other comonomer that may be present. Examples of T_{g} are shown in FIG. 1 of the aforementioned U.S. Pat. No. 4,754,009 of E. N. Squire as ranging from about 260° C. for copolymers with tetrafluoroethylene having low amounts of tetrafluoroethylene comonomer down to less than 100° C. for the copolymers containing at least 60 mole % of tetrafluoroethylene.

Various microporous materials made of fluoropolymer films and sheeting, are known and are suitable for use in the invention. For example, U.S. Pat. No. 3,664,915 discloses uniaxially stretched film having at least 40% voids or pores, and as noted above, U.S. Pat. No. 3,953,566 to Gore & Associates discloses porous PTFE films having at least 70% voids.

Expanded fluoropolymers such as ePTFE and other suitable materials for use as support layers for the composites in the invention are commercially available, for example from W.L. Gore and Associates or from Donaldson. In particular, Donaldson Tetratex® membrane products are available having a variety of thicknesses, width and pore sizes. For example, membranes are available having a thickness from 0.4 mil to 10 mil, and a width from 24 inches to 87 inches. Furthermore, commercially available films contain pore sizes from about 0.07 μm to about 2.8 μm or higher. For example, Tetratex® 3108 is 0.2-mils thick. with 2.8-micron pores, while Tetratex® 1316 is 0.4 mils thick with 0.07-micron pores.

The multilayer composites contain ionomer imbibed into the porous support layers described above. Suitable ionomers include a variety of polymeric materials that do not interfere with operation of the fuel cell and contain a proton transporting group. Suitable proton transporting groups include generally charged inorganic groups, especially those containing phosphorous and sulfur. Examples include sulfate, sulfonate, sulfinate, phosphate, phosphonate, and phosphinate inorganic groups. The inorganic groups containing phosphorous or sulfur are generally present in the ionomers in the acid form.

Preferred ionomers include those having sulfonic acid groups —SO₃H present on a polymer backbone. A preferred commercial embodiment of such an ionomer is perfluorosulfonic acid ionomer. Chemically, they are based on polymers and copolymers of perfluorosulfonic acid monomers. In a preferred embodiment, the ionomers contain a polymerized tetrafluoroethylene backbone on which side chains containing perfluorinated vinyl ether are bonded by oxygen atoms. Sulfonic acid groups on the side chain give the polymer a cation exchange capability. The proton exchange capacity of the ionomers is measured by its equivalent weight, or the mass per hydroxide equivalent of active sulfonic acid group. Commercially available perfluorosulfonic acid polymers are available with equivalent weights from about 700 to about 1200. When the equivalent weight of the ionomer is low, such as 700, it is preferred to anneal the multilayer composite after assembly and drying as described herein. The annealing or heat treatment is preferably carried out at an elevated temperature for a suitable time. Exemplary annealing conditions include heating at about 160° C. for about 16 hours.

In a preferred embodiment, the perfluorinated sulfonic acid polymers can be represented by the formula 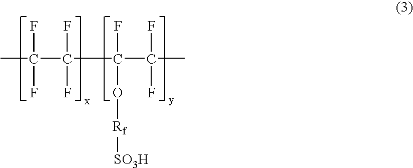
where R_{f} represents a perfluoroalkylene or perfluorooxyalkylene group, and x and y are the relative proportion of perfluoromonomer and sulfonated monomer respectively, in the polymer. The equivalent weight of the polymer is determined in part by the relative ratio of x and y, and in part by the relative size of the connecting group R_{f}, which preferably has from 2 to 10 carbon atoms. Two commercial embodiments are given by the formulas (4) and (5) 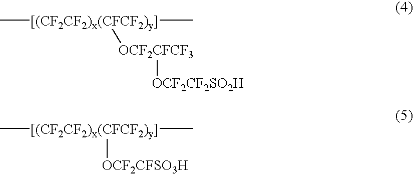
Formula (4) represents a “long chain” perfluorosulfonic acid polymer, while (4) represents a “short chain” polymer. In general, lower equivalent weights may be attained by using the short chain polymers. The perfluorosulfonic acid polymers are referred to as ionomers.

Dispersions of suitable ionomers or perfluorosulfonic acid polymers are commercially available. For example, suitable dispersions for use in preparing the electrolyte membranes of the invention contain from about 5% to about 20% by weight of the perfluorosulfonic acid polymer. Higher concentrations may be used as well. The products are provided as dispersions in water (such as 30 to 40 wt. % water) plus up to about 50% (or more) of a volatile organic component such as 1-propanol. Suitable commercial polymer dispersions are sold by DuPont and by Asahi Kasei Corporation, under the Nafion® and the Aciplex® trade names, respectively.

One method of making multilayer composites of the invention involves imbibing individual structural layers with ionomer and building up the composite by stacking or laying successive layers one on top of another. Alternatively, it is possible to construct a dry “sandwich” from a plurality of lay-ups that consist of the structural layer without the ionomer imbibed into the pores. After the sandwich is laid up, the ionomer composition is imbibed into all of the structural layers. If the porosity and thickness of the individual layers is suitable, and the ionomer composition being imbibed contains surfactant or other materials that allow penetration of the ionomers into the interior of the individual layers, suitable membranes can be constructed from a dry sandwich.

To further illustrate a method of the invention, a composite membrane is formed by first immersing a porous structural layer such as an ePTFE film into a dispersion of an ionomer such as PFSA. On immersion, the membrane swells and the pores become imbibed with the ionomer macromolecules, polymer aggregates, or particles. It is normally observed that the appearance of the film changes from an opaque to a clear appearance, as the ionomer is imbibed In a preferred embodiment, the swollen film is then dried under tension to prevent the film from wrinkling and contracting. Next, another layer of wet ionomer-imbibed ePTFE film is applied over the first dried layer and then the two layers are dried together to form a two layered sandwich type structure. The multi-layering process to form a multilayer sandwich structure can then be repeated until a membrane of desired thickness is achieved. As noted, in preferred embodiments the composite is laid up in such a way that the orientation of fibers in adjacent layers varies by about 100 up to 90° (absolute value).

Alternatively, a sandwich structure can be made in which an ionomer dispersion is first cast onto a dried layer of ionomer imbibed support structure before yet another wet composite layer of ionomer-imbibed ePTFE is applied. The composite structure is then dried again. In this way, two, three, and more layers can be built up to form a composite structure. In various embodiments, the resultant composite membrane has enhanced physical property strength compared with a single layer membrane made with a single support layer. Composite membranes combining two layers and three layers are preferred. In various embodiments, an improvement in strength of the membrane is observed even when there are two layers. When the composite membrane layers contain three layers, a preferred embodiment is for relatively thicker layers to form outside layers, while a third layer is a center inside layer.

The overall number of layers and total thickness of the membranes is limited by the ability of the resulting membrane to conduct protons and maintain suitable cell voltage during operation of a fuel cell. In preferred embodiments, the composite membranes have a maximum of four, and a preferred maximum of three layers, and have a thickness of no more than about 100 μm and preferably less than or equal to about 50 μm. As more and more layers are added or as the membrane becomes thicker than the preferred ranges given above, it is believed a point would eventually be reached where a proton path through the composite membrane is so convoluted or tortuous that proton conduction through the membrane would be inhibited or lessened to an extent that unsatisfactory cell performance could result.

Optionally, the multilayer composites of the membrane made by methods such as described above are provided with backings for ease of handling or further processing. In various embodiments, the backings are used for ease of handling and are conveniently removable upon assembly of the fuel cell. Peel-off backings are suitable for this use. For use in the fuel cell, the backing should have certain properties. For example, the backing should be porous so that ionomer can be imbibed into it and so that the composite membrane containing the backing will provide adequate proton transport operation during operation of the fuel cell. In preferred embodiments, the backing is used for ease of handling and is removed before building and operating the fuel cell.

In various embodiments, the backing is made from woven or non-woven material. Suitable woven materials include without limitation scrims made of woven fibers of expanded porous PTFE; webs made of extruded or oriented linear polyethylene, polypropylene or polypropylene netting, commercially available for example from Conwed Inc. of Minneapolis, Minn.; and woven materials of polypropylene and polyester, such as are commercially available from Pepco Inc. of Briar Cliffe Manor, N.Y., and non-wovens available from Crane and Co., Inc., 30 South St., Dalton, Mass. 01226). Suitable non-woven materials include without limitation a spun bonded polypropylene such is available from Remay.

Peelable backings are made of a variety of materials that are available in sheet form and adhere only weakly to the multilayer composites of the invention. Suitable materials include extruded polyolefin sheets such as polypropylene and polyethylene and specialty treated papers available from Avery, Buffalo, N.Y.

The invention has been described above with respect to various preferred embodiments. Further non-limiting description is given in the Examples that follow.

### EXAMPLES

### Example 1a

### Tetratex® 1316/3108 Sandwich

A 5×5 inch sq. of Tetratex™ 1316 (expanded PFTE membrane of 0.4-mil thickness and 0.07-μm average pore size) is immersed into a dispersion of PFSA. Exemplary dispersions include a 5% solution available from Asahi Kasei with an equivalent weight of 900 and a 20 wt % solids solution in aqueous 1-propanol of PFSA ionomer with an equivalent weight of 1000 available from DuPont as Nafion® DE2020. The ePTFE-membrane support structure is observed to swell as it imbibes PFSA ionomer. The swollen film is then dried under tension by adhering it to a glass slide.

Next, a 5-in×5-in. sq. of Tetratex™ 3108 (ePTFE membrane 0.2-mil thickness) is immersed into the PFSA dispersion; the ionomer-imbibed layer is then applied over the first dried layer at a 90° angle with respective to fiber direction. The two layers are then dried together to form a two layered sandwich structure, comprising two porous structural layers with imbibed ionomer. The multilayer composite membrane is 40 μm thick, after heating between 90° and 140° C. for at least one hour.

### Example 1b

### Tetratex 1316/1316 Sandwich

In a way similar to Example 1a, a composite structure is made where both layers are Tetratex 1316 imbibed with Aciplex 900 SS ionomer (900 equivalent weight). The two layers are oriented at 90°.

### Example 1c

### Tetratex 3107/3107 Sandwich

Similar to Example 1a, a composite structure is made where both layers are Tetratex 3107 imbibed with Aciplex 700 SS ionomer (700 equivalent weight). The layers are oriented at 90°. After drying, the composite is heat treated at 160° C. for 16 hours. The composite is 30 μm thick.

### Example 1d

### Tetratex 1316/1316 Sandwich

This is like Example 1b, except that the layers of 1316 are imbibed with Aciplex A-K 700 SS ionomer (700 equivalent weight). After drying, the composite is annealed in an oven at 160° C. for 16 hours. The membrane is 35 μm thick.

### Example 2a

The composite membrane of Example 1a is used as proton exchange membrane in a fuel cell. The multilayered membrane is tested in a PEM fuel cell at 80° C. with a hydrogen-air stoichiometry of 2/2, pressure of 50 kPa and with humidified gases with 50% relative humidity on the anode and cathode side. The electrodes are made with catalyst coated on a microporous layer coating on diffusion media with a platinum catalyst loading of 0.4 mg/cm². At a current density of 0.2 A/cm², the cell voltage is 0.78 V while at a current density of 2 A/cm², the cell voltage is about 0.5 V. The high frequency resistance over the same range of current density is in the range of 0.05 to 0.06 ohm*cm².

### Example 2b

The composite membrane of example 1c is tested in the fuel cell test of Example 2a. Cell voltage is 0.798 V at 0.2 A/cm² and 0.63 V at 0.8 A/cm².

### Example 2c

The composite membrane of example 1d is tested in the fuel cell test of Example 2a. Cell voltage is 0.795 V at 0.2 A/cm² and 0.544 V at 0.8 A/cm².

### Comparative Example 2

In comparative Example 2 a single layer 18-μm thick ePTFE membrane with imbibed PFSA (one layer of Tetratex 1316) is tested in the same fuel cell configuration as in Example 2. At a current density of 0.2 A/cm² the cell voltage is the same as that of Example 2, while at a current density of 2 A/cm², the cell voltage is 0.45 V. The high frequency resistance throughout the range of current density is from 0.07 to 0.09 ohm*cm².

### Example 3

### Physical Properties of Sandwich Membranes

The tear test for a Tetratex 1316/Aciplex (Asahi-Kasei 900SS) sandwich membrane of Example 1b shows a “tear modulus” value of 64 MPa versus 18 MPa for a single layer; and an energy to break of 933 kJ/m² compared to 149 kJ/m² for a single-layer, supported membrane. At 23° C. and 30% relative humidity, the Tetratex 1316/Aciplex 900 SS sandwich membrane as compared with a single layer supported membrane (in parentheses) shows tensile stress of 82 mPa (vs. 35mPa), a yield stress of 49 MPa (vs 18 mPa), a modulus of 926 MPa (vs. 418 MPa), a % elongation of 37% vs. (171%), and a yield stress of 9% (vs 6%).

While the invention has been described above with respect to various enabling disclosures, it is to be understood that the invention is not limited to the disclosed embodiments. Variations and modification that would occur to one of skill in the art upon reading the description are also within the scope of the invention, which is defined in the appended claims.

What is claimed is:

1. A multilayer composite membrane suitable for use as a proton exchange membrane in a PEM fuel cell, comprising two or more adjacent layers of support structures imbibed with ionomer,
wherein the support structure comprises a fluoropolymeric material having a porous microstructure, and
wherein the ionomer comprises a polymer containing a proton transporting group.

2. A composite membrane according to claim 1, wherein the ionomer comprises a perfluorosulfonic acid polymer.

3. A composite membrane according to claim 1, wherein the fluoropolymeric material comprises a homopolymer of tetrafluoroethylene.

4. A composite membrane according to claim 1, wherein the fluoropolymeric material comprises a copolymer of tetrafluoroethylene.

5. A membrane electrode assembly comprising a proton exchange membrane according to claim 1.

6. A fuel cell comprising a membrane electrode assembly according to claim 5.

7. A membrane electrode assembly suitable for use in a PEM fuel cell, comprising
a cathode,
an anode,
a proton exchange membrane disposed between the cathode and anode,
wherein the proton exchange membrane comprises a multilayer composite, the composite comprising a plurality of expanded fluoropolymer support layers and ionomer macromolecules, polymer aggregates, or particles of perfluorosulfonic acid polymers imbibed into pores of the support layers.

8. A membrane electrode assembly according to claim 7, wherein the proton exchange membrane contains two support layers.

9. An electrode membrane assembly according to claim 7, wherein the proton exchange membrane contains three support layers.

10. An membrane electrode assembly according to claim 7, wherein the thickness of the proton exchange membrane is up to about 50 μm.

11. A membrane electrode assembly according to claim 7, wherein the support layers comprise expanded ePTFE.

12. A membrane electrode assembly according claim 7, wherein the support layers comprise porous fluorocarbon polymer having porosity of 40-95%.

13. A membrane electrode assembly according to claim 7, wherein the support layers comprise porous fluorocarbon polymer having Gurley numbers of from about 0.1 to about 8 seconds.

14. A membrane electrode assembly according to claim 7, wherein the support layers comprise ePTFE and PFSA polymers, the PFSA having equivalent weight from 700 to 1100.

15. A fuel cell comprising a membrane electrode assembly according to claim 7.

16. A fuel cell stack comprising a plurality of fuel cells according to claim 15.

17. A method of operating a PEM fuel cell to supply an electromotive force for operation in the use of electrically driven motors, comprising supplying a reactant gas comprising hydrogen to the anode and an oxidizing gas comprising oxygen to the cathode of a PEM fuel cell,
wherein the fuel cell comprises a proton exchange membrane comprising two or more adjacent layers of support structures imbibed with ionomer particles,
wherein the support structure comprises fluoropolymeric material having a porous microstructure, and
wherein the ionomer comprises a polymer containing a proton transporting group.

18. A method according to claim 17, wherein the ionomer comprises perfluorosulfonic acid.

19. A method according to claim 17, wherein the support layers comprise expanded polytetrafluoroethylene (ePTFE).

20. A method according to claim 17, wherein the support layers have a porosity of 35-95%.

21. A method according to claim 17, wherein the support layers comprise porous fluoropolymer characterized by a Gurley time from about 0.1 to about 8 seconds as determined with a Gurley apparatus.

22. A method according to claim 17, wherein the polyelectrolyte proton exchange membrane has a thickness up to about 50 μm.
